(19) United States
(12) Patent Application Publication
(10) Pub. No.: US 2021/0378182 A1
(43) Pub. Date: Dec. 9, 2021

(54) METHOD AND COMPUTER SYSTEM FOR ASSISTING USER IN PLANT CARE

(71) Applicant: Hangzhou Glority Software Limited, Hangzhou (CN)

(72) Inventors: Qingsong Xu, Hangzhou (CN); Qing Li, Hangzhou (CN)

(73) Assignee: Hangzhou Glority Software Limited, Hangzhou (CN)

(21) Appl. No.: 17/137,302

(22) Filed: Dec. 29, 2020

(30) Foreign Application Priority Data
Jun. 8, 2020 (CN) 202010513709.7

(51) Int. Cl. A01G 7/06; A01G 7/04; A01B 79/02; A01B 79/00; G06Q 10/06; G06F 16/9035

(52) U.S. Cl. CPC A01G 7/06; A01G 7/04; G06F 16/9035; A01B 79/005; G06Q 10/06393; A01B 79/02

(57) ABSTRACT

The disclosure relates to a computer-executable method for assisting a user in plant care, including the following steps. A plant added by the user is received. A care task of the plant is determined at least according to a type of the plant, a planting location of the plant, and a current time. The user is prompted of the care task of the plant.

### CROSS-REFERENCE TO RELATED APPLICATION

This application claims the priority benefit of China application serial no. 202010513709.7, filed on Jun. 8, 2020. The entirety of the above-mentioned patent application is hereby incorporated by reference herein and made a part of this specification.

### BACKGROUND

### Technical Field

The disclosure relates to the field of computer technology, and in particular, to a method and a computer system for assisting a user in plant care.

### Description of Related Art

People often place plants in their homes or workplaces, and these plants need to be cared for regularly, such as watering, pruning, and pest elimination. Taking watering as an example, different plants have different water demands and require different watering frequencies. When there are many types of plants to be cared for, it may be difficult for people to remember exactly when each plant needs to be watered.

### SUMMARY

An objective of the disclosure is to provide a method and a computer system for assisting a user in plant care.

A first aspect of the disclosure provides a computer-executable method for assisting a user in plant care, including the following steps. A plant added by the user is received. A care task of the plant is determined at least according to a type of the plant, a planting location of the plant, and a current time. The user is prompted of the care task of the plant.

A second aspect of the disclosure provides a computer-executable method for assisting a user in plant care, including the following steps. Multiple plants added to a garden created by the user are received. At least one care task of each of the plants is determined at least according to a type of each of the plants, a location of the garden, and a current time. The user is prompted of each of the care tasks of the multiple plants.

A third aspect of the disclosure provides a computer system for assisting a user in plant care, including one or more processors, and one or more memories configured to store a series of computer-executable commands. When the series of computer-executable commands are executed by the one or more processors, the one or more processors are caused to perform the method above.

A fourth aspect of the disclosure provides a non-transitory computer-readable storage medium, storing a series of computer-executable commands. When the series of computer-executable commands are executed by one or more computing devices, the one or more computing devices are caused to perform the method above.

Through the following detailed description of exemplary embodiments of the disclosure with reference to the accompanying drawings, other features and advantages of the disclosure will be clearly understood.

### BRIEF DESCRIPTION OF THE DRAWINGS

The accompanying drawings constituting a part of the specification illustrate the embodiments of the disclosure, and together with the specification, serve to explain the principle of the disclosure.

With reference to the accompanying drawings, the disclosure may be understood more clearly according to the following detailed description.

FIG. 1 is a flowchart schematically showing at least a part of a computer-executable method for assisting a user in plant care according to an embodiment of the disclosure.

FIG. 2 is a flowchart schematically showing at least a part of a computer-executable method for assisting a user in plant care according to an embodiment of the disclosure.

FIG. 3A to FIG. 3C are views schematically showing pages provided by an application program which executes a method according to an embodiment of the disclosure.

FIG. 4 is a view schematically showing a page provided by an application program which executes a method according to an embodiment of the disclosure.

FIG. 5 is a view schematically showing a page provided by an application program which executes a method according to an embodiment of the disclosure.

FIG. 6 is a view schematically showing intelligent adjustment of a date of a care task in a computer-executable method for assisting a user in plant care according to an embodiment of the disclosure.

FIG. 7 is a structural view schematically showing at least a part of a computer system for assisting a user in plant care according to an embodiment of the disclosure.

FIG. 8 is a structural view schematically showing at least a part of a computer system for assisting a user in plant care according to an embodiment of the disclosure.

It is noted that in the embodiments described below, the same reference numeral is sometimes used among different drawings to denote the same part or parts having the same functions, and repeated descriptions thereof are omitted. In this specification, similar reference numerals and letters are used to indicate similar items. Therefore, once an item is defined in a drawing, it does not need to be further discussed in subsequent drawings.

### DESCRIPTION OF THE EMBODIMENTS

Hereinafter, various exemplary embodiments of the disclosure will be described in detail with reference to the accompanying drawings. It is noted that, unless specifically described otherwise, the relative arrangements, numerical expressions, and numerical values of the components and steps described in the embodiments do not limit the scope of the disclosure. In the following description, for a comprehensive understanding of the disclosure, many details will be described, but it is understood that the disclosure may also be implemented without these details.

The following description of at least one exemplary embodiment is actually only illustrative and does not limit the disclosure and its application or use in any way. In all examples shown and discussed herein, any specific value should be interpreted as merely exemplary rather than limiting.

The techniques, methods, and equipment known to those of ordinary skill in the relevant arts may not be discussed in detail herein, but where appropriate, the techniques, methods, and equipment should be regarded as part of the specification.

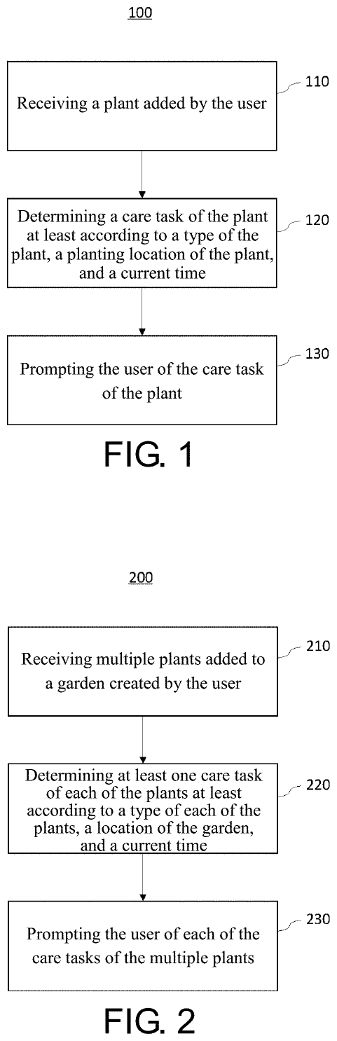

FIG. 1 is a flowchart of a method 100 for assisting a user in plant care according to an embodiment of the disclosure. The method 100 may be executed by an application program to provide the user with assistance functions in plant care. The application program may be installed on an electronic device such as a computer and a mobile phone. The method 100 includes the following steps. A plant added by a user is received (step 110). A care task of the plant is determined at least according to a type of the plant, a planting location of the plant, and a current time (step 120). The user is prompted of the care task of the plant (step 130).

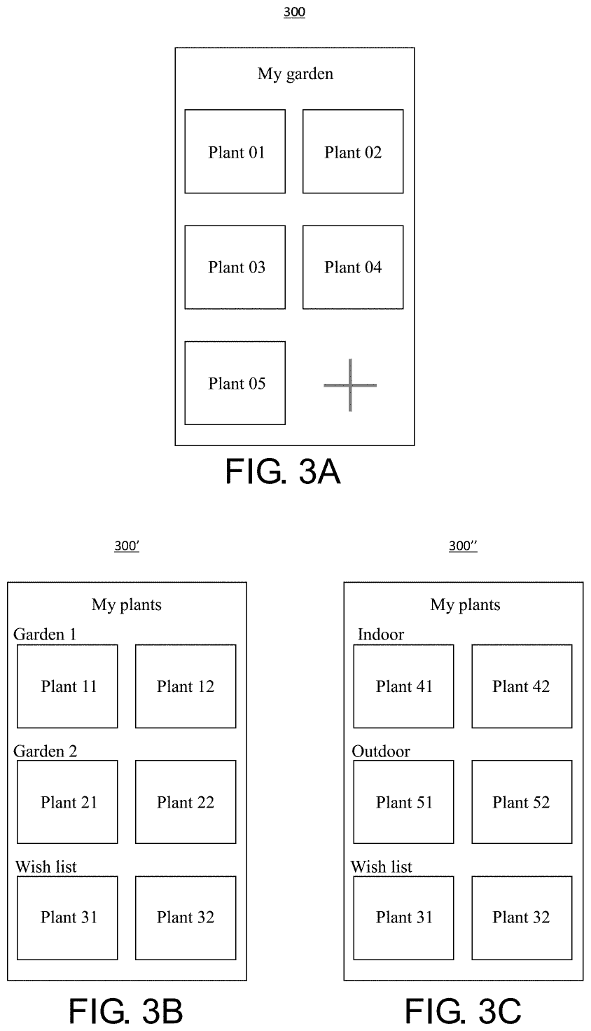

The application program performs step 110 included in the method 100 to receive a plant added by the user. The user may create one or more “gardens” by using the application program. It is understood that the garden created by the user as referred to herein refers to a set including one or more plants, and it does not have to have a specific physical form. In some cases, the user may add one or more plants which he/she cares for at home or in the workplace, e.g., on the balcony, in the courtyard, in the office, etc., to the garden which he/she creates. In some cases, the user may add one or more plants from the garden or public green space which he/she is responsible for managing to the garden which he/she creates. It is understood that the plants added by the user to the same garden may be located at the same physical location or at different physical locations. For example, the user may create a garden and add plants located at home and in the workplace both to the garden, and it is also possible to create separate gardens for plants located at home and plants located in the workplace, and add the plants to their respectively corresponding gardens. FIG. 3A is a page 300 displayed via a user interface provided by the application program, which schematically shows a garden created by the user. In this example, multiple plants (plant 01 to plant 05) have been added to the garden. The region corresponding to each plant in the page 300 may display a picture (which may be a picture from the user or from the Internet, and may be a static or dynamic picture, video, etc.) and/or a name of the plant. The user may add a plant to the garden by operating a specific region in the user interface, e.g., the “+” symbol region at the lower right part of the page 300. For example, after operating the “+” symbol region, the user can add the plant by uploading a picture of the plant to the application program or inputting a name (including a scientific name, a common name, a user-defined nickname, etc.) of the plant to the application program. In addition, it is understood that, although not shown in the drawings, the user may also add a plant to the created garden through other methods. For example, it is possible to operate on a plant-related page provided by this application program or other application programs to add the plant to the garden of the user.

The plant-related page may be, for example, a result display page of plant identification, a browse page of plant details, etc. This application program or other application programs linked to this application program may provide a plant identification function, and the user may input a picture containing a plant to the application program to have the application program identify the plant in the picture based on a neural network model established in advance through sample training to thereby output a result display page of plant identification to the user. The page may include the name of the plant and other information (e.g., plant description, current growth period of the plant, current growth state assessment of the plant, etc.), and it may also include an operation region for the user to operate (e.g., a memo for the user to record the growth of the plant, etc.). In response to the user's operation on the operation region, the plant displayed on the result display page may be added to the garden.

The user may also create one or more “wish lists” by using the application program, and each wish list may include one or more plants. The plants may be plants that the user wishes to plant/care for but have not yet planted/cared for, or may be those that have been planted/cared for. FIG. 3B is a page 300′ displayed via the user interface provided by the application program, which schematically shows gardens and a wish list created by the user. In this example, multiple gardens (garden 1 and garden 2) and a wish list are created, and multiple plants are added to each garden and the wish list.

The plants added to the garden may include an attribute of the planting environment, and the planting environment of the plant may be determined according to the user's input. The planting environment of the plant may include, for example, at least one of indoor, outdoor, potted, ground-grown, soil cultured, and hydroponic. For example, the planting environment of the plant may be indoor potted, outdoor hydroponic, etc. For example, the user may edit the attribute of the planting environment of the plant when adding the plant to the garden, or may edit the attribute for the plant at any time after the plant has been added to the garden. In an embodiment, if a plant is received and added to the garden, a page is displayed for the user to input a text to edit the planting environment of the plant. In an embodiment, if a plant is received and added to the garden, a page which provides options of the planting environment is displayed to allow the user to select the planting environment of the plant to facilitate the user input. In addition, default values of the options may also be provided. For example, for a plant suitable for hydroponics, while providing various options of the planting environment, the option “hydroponic” is also selected by default. The user may directly confirm the planting environment, namely, confirming that the planting environment of the plant is hydroponic. Of course, the user may also select other options, and then confirm the planting environment of the plant.

Some options in the planting environment of the plant may be related. For example, plants located indoors are generally potted plants. Therefore, when the application program provides the page of options of the planting environment for the user to select the planting environment of the plant, it may first provide the indoor and outdoor options. If the user selects the indoor option, the application program may determine by default that the planting environment of the plant further includes “potted”. If the user selects the outdoor option, the application program may pop up further options including “potted” and “ground-grown” for the user to further select. It is understood that the planting environment of the plant may also be related to the type of the plant. For example, if the user selects the outdoor option, and the type of the plant is an air plant or an aquatic plant, the application program may determine by default that the planting environment of the plant further includes “potted”. If the user selects the outdoor option, and the type of the plant is not an air plant or an aquatic plant, the application program may pop up further options including “potted” and “ground-grown” for the user to further select. If the user selects the indoor option, and the plant is a plant suitable for hydroponics, the application program may pop up a further option to ask whether the planting environment of the plant includes “hydroponic”.

The user may also input the planting environment of the plant by uploading a picture of the plant to the application program. In that case, the application program may identify the planting environment of the plant based on the picture (e.g., identifying based on a neural network model established in advance through sample training), and determine the attribute of the plant in the garden accordingly.

FIG. 3C is a page 300″ displayed via the user interface provided by the application program, which schematically shows a garden and a wish list created by the user. In this example, a garden and a wish list are created, multiple plants of the indoor planting environment and multiple plants of the outdoor planting environment are added to the garden, and multiple plants are added to the wish list. Although the term “garden” is not shown in the page 300″, it is understood that the page 300″ should still be regarded as showing the garden created by the user.

The plants added to the garden may include an attribute of the type, and the type of the plant may be determined according to the user's input. For example, the user may edit the attribute of the type of the plant when adding the plant to the garden, or may edit the attribute for the plant at any time after the plant has been added to the garden. The user may also input the type of the plant by uploading a picture of the plant to the application program. In that case, the application program may identify the type of the plant based on the picture (e.g., identifying based on a neural network model established in advance through sample training), and edit the attribute of the plant in the garden accordingly. In an embodiment, the type of the plant may be a category in botanical classification such as Rosaceae. In an embodiment, the type of the plant may include one of a tree, a shrub, an herb, and a vine. In an embodiment, the type of the plant may include one of terrestrial, aquatic, epiphytic, parasitic, and saprophytic plants.

In an embodiment, the application program may allow the user to set a planting location for each plant in the garden, and the planting location of each plant may be the same or different. In an embodiment, to facilitate the user's operation, the application program may allow the user to set a planting location for the garden, and may determine the planting location of each plant in the garden accordingly. Although the application program provides the user with this convenient function, it is understood that the user may still set a planting location for one or more plants in the garden to be different from the planting location of the belonged garden. In an embodiment, the application program may set the planting location set by the user as the highest priority. In response to receiving the location inputted by the user, the application program may correspondingly determine the location of the garden and/or the plant as the location inputted by the user. In response to not receiving the location inputted by the user, the application program may determine the location of the garden and/or the plant according to the positioning information of an electronic device. The electronic device may be the electronic device through which the user uses the application program. If the user uses the application program through multiple electronic devices, the location of the garden and/or the plant may be determined according to the positioning information of any of the electronic devices. The positioning information of the electronic device may include GPS information and/or IP address information. As will be described below, the planting location may be used to determine the climatic region or geographic region where the plant is located to thereby determine a care task of the plant. Therefore, it is possible that the planting location does not have high accuracy. For example, the planting location inputted by the user may be accurate only to the scale of districts, cities, etc., and the positioning error may be several hundred meters or even several kilometers, which is not limited in the disclosure.

In another embodiment, the application program may also allow the user to provide care assistance for plants planted by a friend (i.e., another user associated with the user). For example, friends who similarly use the application program may see the plants planted by friends and share the care state. When a friend is out for a long time, this friend may send out an assistance request (e.g., according to the location of the plant; for example, in the case of a plant in the office, a request may be sent to a befriended colleague, and in the case of a plant in the outdoor garden at home, a request may be sent to a befriended neighbor) to request a friend for plant care. The application program may send such a request to a friend, and the friend who receives the request information may help water, fertilize, prune, etc. the plant in the office or outdoor garden of the friend according to the prompt information of the shared care state of the friend.

In addition, the application program also allows friends to share plant care experience and the like, which is not limited in the disclosure.

In step 120, the method 100 determines a care task of the plant at least according to a type of the plant, a planting location of the plant, and a current time. The care task may include, for example, at least one of watering, spraying, water changing, water adding, fertilizing, pruning, weeding, pot turning, repotting, sunshining, sunshading, temperature adjustment, humidity adjustment, winter protection, and pest protection. It is noted that not every plant requires all of the above care tasks. Some care tasks are also related to the planting environment. For example, the pot turning and repotting tasks are care tasks specific to potted plants, and the pot turning task may be further specific to plants of the indoor potted planting environment. For some plants of the soil cultured planting environment, not only watering but spraying may also be required, and both the watering task and the spraying task may be prompted. For plants of the hydroponic planting environment, water changing may be prompted instead of prompting the watering task or the spraying task. Some care tasks are related to the type of the plant. For example, for plants of the air plant type, watering is not required for daily care, and it is possible to prompt the spraying task only. For plants of the aquatic plant type, the water adding task may be prompted instead of prompting the watering, spraying, or water changing task. Some care tasks may also be related to the growth stage of the plant, such as the pot turning task. In addition to being specific to indoor potted plants, the prompt for the pot turning task may be set further specific to plants of which the growth stage is the growth period, the flowering period, or the fruiting period.

For example, the method 100 may determine the climatic region/geographic region in which the plant is located according to the planting location of the plant, then determine the seasonal unit according to the climatic region/geographic region in which the plant is located and the current time, and determine the care task of the plant according to the type of the plant and the seasonal unit. In an embodiment, the geographic regions may be divided according to the landform and include, for example, a plain region, a plateau region, etc. In an embodiment, the geographic regions may be divided according to administrative regions and include, for example, an administrative city, an administrative district, etc. In an embodiment, the climatic regions may be climatic regions classified according to the Köppen climate classification. According to the Köppen climate classification, various regions around the world are divided into different climatic regions, so that the climatic region of the planting location of the plant can be determined. For example, according to the latitude and longitude information of the planting location of the plant, the corresponding climatic region in which the plant is located can be found among the various climatic regions around the world based on the inverse Mercator projection method.

In an embodiment, the time division among the seasonal units of each climatic region/geographic region may be determined to thereby establish a lookup table as shown in Table 1 below, so as to determine the seasonal unit according to the climatic region/geographic region and the current time. Each row in Table 1 corresponds to a climatic region/geographic region, and each column corresponds to a seasonal unit. The value in each unit in the table indicates the day on which the corresponding region enters the corresponding seasonal unit, i.e., the day number of the year to enter the seasonal unit. For example, the region 1 enters the seasonal unit 2 on the 18^{th} day of each year. The absence of value in the unit means that the corresponding region does not have the corresponding seasonal unit. It is noted that if the time division of the seasonal units is established based on the features of the northern hemisphere, the value of the unit in a lookup table of the southern hemisphere will need to be corrected, for example, by adding 183 (modulo 365) to the values in the table of the northern hemisphere.

TABLE 1
Seasonal unit lookup table

| Time | Seasonal | Seasonal | Seasonal | Seasonal |
|---|---|---|---|---|
| division | unit 1 | unit 2 | unit 3 | unit 4 |
| Region 1 | — | 18 | — | 315 |
| Region 2 | 19 | 101 | 301 | — |
| Region 3 | 36 | — | 189 | 342 |
| Region 4 | 167 | — | 212 | 257 |

In an embodiment, the seasons of each year may be divided into 12 seasonal units. For example, the seasonal unit may include one of early spring, mid spring, late spring, early summer, mid summer, late summer, early autumn, mid autumn, late autumn, early winter, mid winter, and late winter. As mentioned above, the current time may be used to determine the seasonal unit according to, for example, the above time division of the seasonal units. Therefore, in the disclosure, the accuracy of the current time may be accurate only to the scale of “day” and does not need to be accurate to the scale of hour, minute, second, etc. Of course, it is understood that the current time may also have higher accuracy.

The care task may be related to the type of the plant and the climate. In an embodiment, according to the type of the plant and the seasonal unit, the determination of the care task of the plant may include determining the frequency at which the care task should be executed. For example, a task frequency lookup table as shown in Table 2 may be established in advance. The value in each unit in the table indicates the frequency at which the care task should be executed, i.e., the interval between task repetitions, and the unit of measurement is days. For example, the corresponding care task should be executed every 17.5 days for the plant type 1 in the seasonal unit 2. The absence of value in the unit means that it is not required to execute the task for the corresponding plant type in the corresponding seasonal unit. For example, it is not required to execute the task for the plant type 2 in the seasonal unit 1. Some care tasks may also be related to the planting environment, and different task frequency lookup tables may be established for different planting environments. For example, the task frequency lookup table as shown in Table 2 may be established respectively for indoor, outdoor, potted, ground-grown, soil cultured, and hydroponic plants.

TABLE 2
Task frequency lookup table

| Repetition | Seasonal | Seasonal | Seasonal | Seasonal |
|---|---|---|---|---|
| interval | unit 1 | unit 2 | unit 3 | unit 4 |
| Plant type 1 | 21 | 17.5 | 14 | 10.5 |
| Plant type 2 | — | 14 | 10.5 | 7 |
| Plant type 3 | 14 | 10.5 | 7 | 5 |
| Plant type 4 | 10.5 | 7 | 5 | 3.5 |

Taking the watering task as an example, respective task frequency lookup tables as shown in Table 2 may be established for indoor potted plants, outdoor potted plants, and outdoor ground-grown plants. For plants of the air plant type, the value in the unit corresponding to the air plants in the watering task frequency lookup table may be set as the frequency of the spraying task. For example, in the established task frequency lookup tables for the indoor potted plants and the outdoor potted plants, the value in the unit corresponding to the air plants is set as the frequency of the spraying task, and in the task frequency lookup table for the outdoor ground-grown plants, there is no value in the unit corresponding to the air plants. For plants of the aquatic plant type, if it is required to prompt the water adding task, the value in the unit corresponding to the aquatic plants in the watering task frequency lookup table may be set as the frequency of the water adding task. If it is not required to prompt the water adding task, the value of the unit corresponding to the aquatic plants in the watering task frequency lookup table may be deleted, or it may even be possible not to provide the unit corresponding to the aquatic plants in the lookup table. In the case where it is not required to prompt the water adding task, it may be possible to only indicate in the plant details or a task overview page (e.g., a page 500 below) that water should be timely added. For plants of the hydroponic planting environment, water changing may be prompted instead of watering. Therefore, a water changing task frequency lookup table for the hydroponic plants may be established separately as described above, or the watering task frequency lookup tables for the indoor potted plants and the outdoor potted plants may be reused, as long as a unit group (e.g., a row corresponding to the hydroponic plants) related to the hydroponic plants is established in the lookup table. For indoor hydroponic plants, the value in the unit corresponding to the hydroponic plants in the watering task frequency lookup table for the indoor potted plants may be set as the frequency of the water changing task. For outdoor hydroponic plants, the value in the unit corresponding to the hydroponic plants in the watering task frequency lookup table for the outdoor potted plants may be set as the frequency of the water changing task.

In the case where the types of plants are defined by the categories in the botanical classification, the number of the types of plants is generally large, so the task frequency lookup table may include two sub-tables. For example, when the care task is watering, the first sub-table may map the types of plants to the water demand. For example, the water demand may be divided into low, medium, high, and very high water demands. For example, for plants of the genus Rosa, the water demand may be determined according to the first sub-table. The second sub-table may map the water demand of each seasonal unit to the watering frequency (e.g., the days of interval for repeating the watering task). For example, for plants of the medium water demand, according to the second sub-table, it may be determined that the interval of the watering task in the seasonal unit of early spring is 17.5 days. Accordingly, based on the watering task frequency lookup table, it can be determined that the interval of the watering task of plants of the genus Rosa in the seasonal unit of early spring is 17.5 days.

After the task frequency is obtained according to the task frequency lookup table, the frequency may be corrected. For example, for the watering task, the following conditions may be considered to adjust the watering frequency obtained from the watering task frequency lookup table: 1) the plant is in a heated indoor environment in a cold season; 2) the plant is in the dormant period; 3) the plant is in the wither period. For example, when the seasonal unit is or is close to early winter, mid winter, and late winter, for plants of the indoor planting environment, the application program may ask the user whether there is heating. In response to receiving a reply that there is heating, the watering frequency during the above seasonal unit obtained from the watering task frequency lookup table is increased, for example, by dividing the interval of repetition of the watering task by two. For plants of which the growth stage is the dormant period and the wither period, the watering frequency obtained from the watering task frequency lookup table is reduced, for example, by multiplying the interval of repetition of the watering task during the dormant period by two and not prompting watering during the wither period. It is understood that for the spraying task of the air plants and the water changing task of the hydroponic plants, the task frequency may similarly be corrected by considering the above conditions.

In an embodiment, the care task is related to the growth stage of the plant. The growth stage of the plant may be determined according to the user's input. The user's input may include a picture showing the form of the plant and/or a text indicating the growth stage of the plant. If the user inputs a picture showing the form of the plant, the application program may determine the growth stage of the plant based on the picture (e.g., identifying based on a neural network model established in advance through sample training). The growth stage of the plant may also be determined according to the current time. The growth stage autonomously determined by the application program may be edited and corrected by the user. The growth stage may include one of a seed/seedling period, a growth period, a flowering period, a fruiting period, a dormant period, and a wither period.

The frequency at which the care task should be executed may be determined according to the growth stage of the plant. For example, a task frequency lookup table as shown in Table 3 may be established in advance. The value in each unit in the table indicates the frequency at which the care task should be executed, i.e., the interval between task repetitions, and the unit of measurement is days. The absence of value in the unit means that it is not required to execute the task for the corresponding plant type in the corresponding seasonal unit, and a unit with a value of −1 means that the task of the corresponding plant type only needs to be executed once in the corresponding growth stage. The frequency at which the care task should be executed may be determined according to the growth stage of the plant based on the task frequency lookup table as shown in Table 3.

TABLE 3
Task frequency lookup table

| Repetition | Growth | Growth | Growth | Growth |
|---|---|---|---|---|
| interval | stage 1 | stage 2 | stage 3 | stage 4 |
| Plant type 1 | 28 | 28 | 28 | −1 |
| Plant type 2 | 28 | 28 | 28 | −1 |
| Plant type 3 | 91 | — | −1 | 91 |
| Plant type 4 | 182 | 28 | 28 | −1 |

After the frequency at which the care task should be executed is determined according to the above method, the dates on which the care task should be executed may be determined. For example, the date on which a task of a plant was executed for the first time may be recorded, then the dates at intervals of the days indicated by the repetition interval in the task frequency lookup table are determined as the dates on which the care task should be executed, and in step 130, the user is prompted of the care task of the plant according to the dates on which the care task should be executed. The date on which the task was executed for the first time may be obtained by the user's input. For example, when a potted plant is added to the garden, the application program may ask the user when the plant was recently repotted. The user may input an exact date or an approximate time such as three months ago, six months ago, one year ago, etc. According to the time, the application program determines the date on which the repotting task of the plant was executed for the first time. In addition, the application program may also set by default the date on which the task was executed for the first time. For example, after a plant is added to the garden, the first-time execution date of one or more tasks of the plant may be set as the day on which the plant is added to the garden. It is understood that the “first time” referred to herein is relative concept and refers to the first time relative to other matters in a specific time period. For example, for a “current task” closest to the current time among the tasks of which the execution dates are to be determined, its “previous task” may be regarded as the first-time task. Correspondingly, for multiple tasks of which the execution dates are to be determined, the current task of which the execution date is closest to the current time may also be regarded as the first-time task.

For the same care task of the same plant, the task frequency may be different in different seasonal units or different growth stages. In some cases, after the current task is completed, the interval between the next task and the current task may be determined according to the seasonal unit or the growth stage of the current task. For example, according to the task frequency lookup table as shown in Table 3, the task repetition interval of the plant type 4 in the growth stage 1 is 182 days, and the task repetition interval in the growth stage 2 is 28 days. If the execution date of the current task is in the growth stage 1, the interval between the next task and the current task may be determined as 182 days, even though the execution date of the next task determined accordingly falls in the growth stage 2. In some cases, after the current task is completed, the plant first goes through a period in which it is not required to execute the task, and then enters a period in which it is required to execute the task. For example, according to the task frequency lookup table as shown in Table 2, the task repetition interval of the plant type 2 in the seasonal unit 4 is 7 days, it is not required to execute the task in the seasonal unit 1, and the task repetition interval in the seasonal unit 2 is 14 days. If the execution date of the current task is in the seasonal unit 4, and the execution date of the next task determined according to the task repetition interval falls in the next seasonal unit, i.e., the seasonal unit 1 in which it is not required to execute the task, then the execution date of the next task is postponed until the execution date enters the seasonal unit in which it is required to execute the task, such as the seasonal unit 2. In addition, it is also necessary to determine whether the interval between the execution date of the next task determined at this time and the execution date of the current task satisfies the interval requirement of the seasonal unit 2. If the requirement is satisfied, the execution date of the next task is determined. If the requirement is not satisfied, it is again postponed until the interval between the execution date of the next task and the execution date of the current task satisfies the requirement. In some cases, the task only needs to be executed once in a specific period. For example, corresponding to the unit with a value of −1 in Table 3, the task associated with Table 3 only needs to be executed once for the plant type 3 in the growth stage 3. If the execution date of the current task is in the growth stage 3, then later on in the same growth stage, i.e., the growth stage 3, the task will not be prompted. In the next growth stage (i.e., the growth stage 4), when the interval between the date and the execution date of the current task satisfies the interval requirement (i.e., 91 days) of the growth stage 4, the date is determined as the execution date of the next task.

If the repetition interval in the task frequency lookup table includes 0.5 days, e.g., 17.5 days, the repetition interval may be regarded as 17 days or 18 days when determining the date. In an embodiment, after the date on which the care task should be executed is determined, the weather corresponding to the date may be obtained, and the user may be prompted of the care task according to the weather. For example, if the planting environment of the plant is outdoor, the care task is watering, and the obtained weather is raining, it may be considered that the watering task has been executed on this day, and the watering task is not prompted this time.

In addition, the determination of the care task may also consider the age and other states of the plant. For example, the care method such as the watering frequency for mature trees and young trees may be different. The state of the plant may be determined according to the user's input. The user's input may include a picture showing the form of the plant and/or a text indicating the state of the plant. If the user inputs a picture showing the form of the plant, the application program may identify the state of the plant based on the picture (e.g., identifying based on a neural network model established in advance through sample training). The state of the plant may also be determined according to the time when the plant was planted and the current time. The plant state autonomously determined by the application program may be edited and corrected by the user.

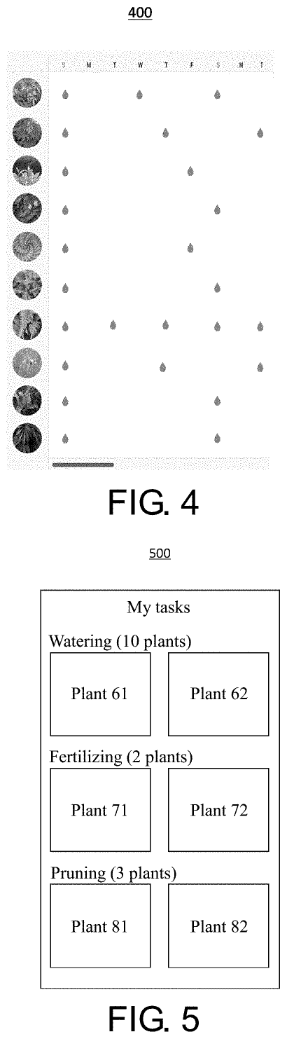

In step 130, the user is prompted of the care task of the plant. FIG. 4 shows a page 400 displayed via the user interface provided by the application program, which schematically shows an example of prompting the user of the care tasks of the plants. In response to receiving the user's operation on the user interface, the application program may display the page 400 to prompt the user of the care task of each plant. The user's operation referred to herein may be a touch, a press, a slide, a click, etc. The page 400 includes the care tasks of the current time period and the future time period displayed in the form of a calendar. One dimension of the calendar is associated with the date, and the other dimension is associated with the plants. The time period referred to herein may include at least one of day, week, and month. For example, the current time period may be the current month, and the future time period may be several months in the future. Although the page 400 only shows prompts for the watering task, it is understood that the application program may prompt multiple care tasks in one page, for example, by distinguishing different tasks by using different icons. For example, a water drop icon may represent the watering task, and a scissors icon may represent the pruning task.

In an embodiment, according to the execution frequency of each care task of each plant, each care task is determined as a more frequently repeated task or a less frequently repeated task. According to the determined dates on which each care task of each plant should be executed, a recent task set and a future task set are established. For example, watering may be a more frequently repeated task, and pruning may be a less frequently repeated task. The recent task set may correspond to the current time period, such as care tasks to be executed in the current month. The future task set may correspond to a future time period, such as care tasks to be executed several months in the future. The recent task set includes the more frequently repeated tasks and the less frequently repeated tasks, the future task set includes the less frequently repeated tasks and does not include the more frequently repeated tasks, and the user is prompted of the recent task set and the future task set. For example, the care tasks of the current month and the care tasks of several months in the future may be displayed in the page 400. The care tasks of the current month may include the watering task and the pruning task, and the care tasks of several months in the future may include pruning.

Therefore, when looking up in the task frequency table according to the above method, the care tasks specific to the growth stage such as the flowering period, the fruiting period, the dormant period, or the wither period cannot be queried. In an embodiment, these specific care tasks are not prompted. In an embodiment, hypothetical prompts are provided for these specific care tasks. For example, if there is a fertilizing task for the plant in the flowering period and the fruiting period, a prompt may be outputted: “If the plant is budding or scaping, please apply the flowering fertilizer once every XX weeks. If the flowering period of the plant ends and fruiting starts, please apply the fruiting fertilizer once every XX weeks.”

In the example of the page 400, the user is prompted of the care tasks in the form of a calendar. It is understood that in other embodiments, a list of the plants in the garden may be displayed in the form of entries, and each plant entry in the list includes the name of the plant and/or the picture of the plant. In response to receiving the user's operation on a plant in the list of multiple plants, another page about this plant is displayed, and the another page may include information of the corresponding plant and one or more care tasks of the plant. In the another page, in response to receiving the user's operation on a care task, a page including information of the care task is displayed.

FIG. 5 shows a page 500 displayed via the user interface provided by the application program, which schematically shows an example of prompting the user of the care tasks of the plants. In response to receiving the user's operation on the user interface, the application program may display the page 500 to prompt the user of the care task of each plant. The page 500 includes a list of care tasks of the current time period and the future time period displayed in the form of entries, including, for example, watering, fertilizing, and pruning. The care task entry in the care task list may include the name of the care task and the number of plants associated with the care task, and may display the plants associated with the care task. In an embodiment, the page 500 may include a sub-page collapsed by default, and the sub-page includes sub-entries of one or more plants (e.g., plant 61) associated with the corresponding care task. The sub-page is displayed after receiving the user's operation on the corresponding care task entry in the care task list. The page 500 may be a state after the collapsed sub-page is displayed. The sub-entry of each plant included in the sub-page includes at least one of the name of the plant, the picture of the plant, the notes on executing the care task, and the frequency of executing the care task.

In an embodiment, the sub-entry of each plant may also include a delay/ignore option. In response to receiving the user's operation on the delay/ignore option, the method 100 may delay/ignore prompting the user of the corresponding care task of the plant corresponding to the sub-entry. In an embodiment, the sub-entry of each plant may also include a completion option. In response to receiving the user's operation on the completion option, the method 100 may end prompting the user of the corresponding care task of the plant corresponding to the sub-entry. In an embodiment, in response to receiving the user's operation on the sub-entry of the plant, the method 100 may switch to display another page, and the another page may include guidance for executing the corresponding care task for the corresponding plant.

To facilitate the execution of the care tasks by the user, especially when there are many tasks, it is possible to schedule the care tasks on weekends as much as possible, i.e., prompting the user to execute these tasks on weekends and reducing the number of days on which the user executes the care tasks. The application program may provide a switch (or option) such as “smart adjustment”, and in response to the switch being turned on (or the option being selected), the task scheduling is intelligently adjusted to schedule the tasks on weekends as much as possible and reduce the number of days on which the tasks are scheduled. In an embodiment, the method 100 may determine whether the days of interval between the determined date on which the care task should be executed and the nearest weekend satisfy an adjustment condition, and if the adjustment condition is satisfied, the determined date on which the care task should be executed is adjusted to the nearest weekend. The adjustment condition may be, for example, that the days of interval between the determined date on which the care task should be executed and the nearest weekend are less than 20% of the days of the repetition interval of the care task. For example, the repetition interval of the watering task is 7 days, and 20% of the days of the repetition interval is 1.4 days. If the determined date of the watering task is Friday, the execution date of the task may be adjusted to Saturday. In an embodiment, the method 100 may determine whether the days of interval between the determined dates on which two care tasks should be executed satisfy an adjustment condition, and if the adjustment condition is satisfied, the execution date of the care task of the long interval is adjusted to the execution date of the care task of the short interval to thereby reduce the number of days on which the user executes the care tasks. In another embodiment, when the adjustment condition is satisfied, the execution date of the care task of a plant later added to the garden is adjusted to the execution date of the care task of a plant previously added to the garden.

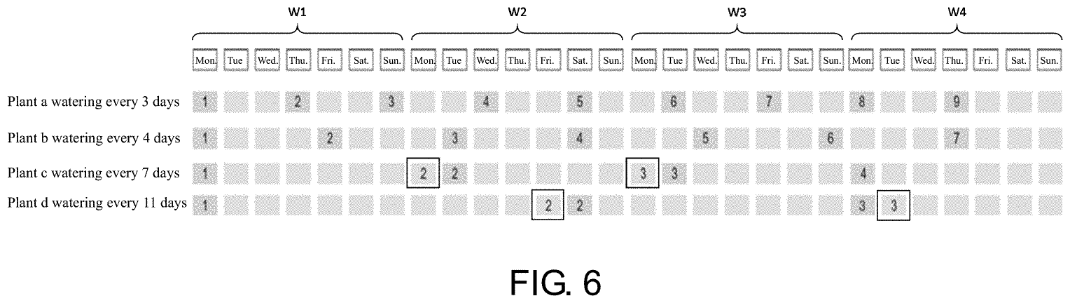

According to the above adjustment condition, the days of interval between the initially determined date and the target adjusted date are less than 20% of the days of the repetition interval of the care task. Therefore, the days of the repetition interval of the care task that can be adjusted need to be greater than or equal to 6 days, and namely, the task dates with an interval of 5 days or less cannot be adjusted. FIG. 6 is a schematic view of intelligent adjustment on the dates of the care tasks. The rows respectively correspond to the plants a to d, the columns respectively represent the dates from the first week W1 to the fourth week W4, and the number in each unit represents the n^{th} task of the corresponding plant. The number with a frame indicates the initially determined task date, and the same number in the same row indicates the target adjusted date of the task. In this specific example, the date of the second-time execution of the watering task for the plant c which has a repetition interval of 7 days may be adjusted from Monday of the second week W2 to Tuesday of the second week W2, so as to be scheduled on the same day as the third-time watering task of the plant b which has a repetition interval of 4 days. The date of the third-time execution of the watering task of the plant c may be adjusted from Monday of the third week W3 to Tuesday of the third week W3, so as to be scheduled on the same day as the sixth-time watering task of the plant a which has a repetition interval of 3 days. The date of the second-time execution of the watering task of the plant d which has a repetition interval of 11 days may be adjusted from Friday of the second week W2 to Saturday of the second week W2, so that the task can be scheduled on the weekend as much as possible and can be scheduled on the same day as the fifth-time watering task of the plant a and the fourth-time watering task of the plant b. The date of the third-time execution of the watering task of the plant d may be adjusted from Tuesday of the fourth week W4 to Monday of the fourth week W4, so as to be scheduled on the same day as the fourth-time watering task of the plant c.

To facilitate the execution of the care tasks by the user, the user's schedule may also be considered when the care task is prompted. In an embodiment, the method 100 may obtain the user's schedule, determine whether the determined dated on which the care task should be executed conflicts with the user's schedule, and, if it conflicts with the user's schedule, adjust the determined date on which the care task should be executed to a date which does not conflict with the user's schedule. FIG. 2 is a flowchart of a method 200 for assisting a user in plant care according to an embodiment of the disclosure. The method 200 may be executed by an application program to provide the user with assistance functions in plant care. The application program may be installed on an electronic device such as a computer and a mobile phone. The method 200 includes the following steps. Multiple plants added to a garden created by a user are received (step 210). At least one care task of each plant is determined at least according to a type of each plant, a location of the garden, and a current time (step 220). The user is prompted of care tasks of the multiple plants (step 230). The method 200 determines the task based on a garden including multiple plants and based on the location of the garden. Since the execution method of each step has been described above, detailed descriptions thereof will be omitted herein.

For a plant added to the wish list, according to the type of the plant and the location of the garden, the period suitable for planting, e.g., the seed/seedling period, is determined. If the current time is close to or falls in the period suitable for planting, the user is prompted to plant at least one plant. On the other hand, in response to receiving the user's operation on the “planted” option of the plant in the wish list, the plant is removed from the wish list and added to the garden.

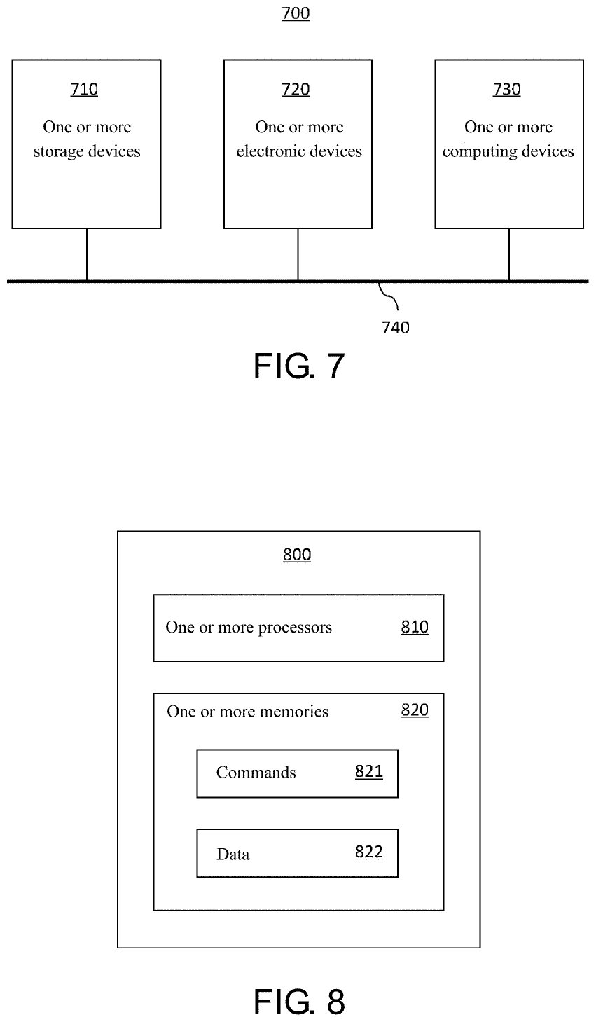

FIG. 7 is a structural view schematically showing at least a part of a computer system 700 for assisting a user in plant care according to an embodiment of the disclosure. Those skilled in the art may understand that the system 700 is merely an example and should not be regarded as limiting the scope of the disclosure or the features described herein. In this example, the system 700 may include one or more storage devices 710, one or more electronic devices 720, and one or more computing devices 730, which may be communicatively connected to each other via a network or bus 740. The one or more storage devices 710 provide storage services for the one or more electronic devices 720 and the one or more computing devices 730. Although the one or more storage devices 710 are shown in a separate box independent of the one or more electronic devices 720 and the one or more computing devices 730 in the system 700, it is understood that the one or more storage devices 710 may actually be stored on any one of other entities 720 and 730 included in the system 700. Each of the one or more electronic devices 720 and the one or more computing devices 730 may be located at a different node of the network or bus 740, and may directly or indirectly communicate with other nodes of the network or bus 740. Those skilled in the art can understand that the system 700 may further include other devices not shown in FIG. 7, and the different devices are located at different nodes of the network or bus 740.

The one or more storage devices 710 may be configured to store any of the data described above, including but not limited to: pictures from the user/Internet, neural network models, samples used to train the neural network models, various attributes of gardens and/or plants (including types, planting locations, growth stages, planting environments, etc.), the premise and/or result of each step (including the current time, the climatic region/geographic region, the seasonal unit, the care task, etc.), various lookup tables, application program files, and other data. The one or more computing devices 730 may be configured to execute at least one or more of the above methods 100 and 200, and/or one or more steps of the methods 100 and 200. The one or more electronic devices 720 may be configured to provide services to the user and, for example, may display the pages 300, 300′, 300″, 400, and 500 as described above. The one or more electronic devices 720 may also be configured to execute one or more steps in the methods 100 and 200.

The network or bus 740 may be any wired or wireless network, and may also include cables. The network or bus 740 may be a part of the Internet, the World Wide Web, a specific intranet, a wide area network, or a local area network. The network or bus 740 may utilize standard communication protocols such as Ethernet, WiFi, and HTTP, protocols that are proprietary to one or more companies, and various combinations of the above protocols. The network or bus 740 may also include, but is not limited to, an Industry Standard Architecture (ISA) bus, a Micro Channel architecture (MCA) bus, an Extended ISA (EISA) bus, a Video Electronics Standards Association (VESA) local bus, and a Peripheral Component Interconnect (PCI) bus.

Each of the one or more electronic devices 720 and the one or more computing devices 730 may be configured to be similar to a system 800 shown in FIG. 8, namely, including one or more processors 810, one or more memories 820, commands, and data. Each of the one or more electronic devices 720 and the one or more computing devices 730 may be a personal computing device used by a user or a commercial computer device used by an enterprise, and may include all the components that are generally used in combination with a personal computing device or a commercial computer device, such as a central processing unit (CPU), a memory (e.g., a RAM and an internal hard disk drive) for storing data and commands, one or more I/O devices such as a display (e.g., a monitor with a screen, a touch screen, a projector, a television, or other devices operable to display information), a mouse, a keyboard, a touch screen, a microphone, a speaker, and/or a network interface device.

The one or more electronic devices 720 may also include one or more cameras for capturing still images or recording video streams, and all components for connecting these devices to each other. Although the one or more electronic devices 720 may each include a full-sized personal computing device, they may optionally include a mobile computing device capable of wirelessly exchanging data with a server via a network such as the Internet. For example, the one or more electronic devices 720 may be mobile phones, or devices such as PDAs with wireless support, tablet PCs, or netbooks which can obtain information via the Internet. In another example, the one or more electronic devices 720 may be wearable computing systems.

FIG. 8 is a structural view schematically showing at least a part of a computer system 800 for assisting a user in plant care according to an embodiment of the disclosure. The system 800 includes one or more processors 810, one or more memories 820, and other components (not shown) which are generally present in devices such as computers. Each of the one or more memories 820 may store content accessible by the one or more processors 810, which may include commands 821 which can be executed by the one or more processors 810, and data 822 which can be searched, manipulated, or stored by the one or more processors 810.

The commands 821 may be any set of commands to be directly executed by the one or more processors 810, such as a machine code, or any set of commands to be indirectly executed, such as a script. The terms “command”, ‘application”, “process”, “step”, and “program” may be used interchangeably herein. The commands 821 may be stored in an object code format for direct processing by the one or more processors 810, or may be stored in any other computer languages, including scripts or sets of independent source code modules which are interpreted on demand or compiled in advance. The commands 821 may include commands which cause, for example, the one or more processors 810 to function as the various neural networks described herein. The rest of the text herein describes in more detail the functions, methods, and routines of the commands 821.

The one or more memories 820 may be any transitory or non-transitory computer-readable storage media capable of storing content accessible by the one or more processors 810, such as hard disk drives, memory cards, ROMs, RAMs, DVDs, CDs, USB memories, writable memories, read-only memories, etc. One or more of the one or more memories 820 may include a distributed storage system, and the commands 821 and/or the data 822 may be stored on multiple different storage devices which may be physically located in the same or different geographic locations. One or more of the one or more memories 820 may be connected to the one or more processors 810 via a network, and/or may be directly connected to or incorporated into any one of the one or more processors 810.

The one or more processors 810 may search, store, or modify the data 822 according to the commands 821. The data 822 stored in the one or more memories 820 may include at least part of one or more of the items stored in the one or more storage devices 710 described above. For example, although the subject matter described herein is not limited by any specific data structure, the data 822 may also be stored in a computer register (not shown), or stored in a relational database as tables or XML documents having many different fields and records. The data 822 may be formatted in any computing device readable format, such as binary value, ASCII, or a Unicode, but are not limited thereto. In addition, the data 822 may include any information sufficient to identify relevant information, such as numbering, descriptive texts, proprietary codes, pointers, references to data stored in other memories at other network locations, or information used by functions to calculate relevant data.

The one or more processors 810 may be any conventional processors, such as central processing units (CPU), graphics processing units (GPU), etc. which are commercially available. Alternatively, the one or more processors 810 may also be dedicated components, such as application specific integrated circuits (ASIC) or other hardware-based processors. Although not required, the one or more processors 810 may include specialized hardware components to perform specific calculation processes faster or more efficiently, e.g., performing image processing on pictures.

Although the one or more processors 810 and the one or more memories 820 are schematically shown in the same box in FIG. 8, the system 800 may actually include multiple processors or memories which may be present in the same physical housing or in different physical housings. For example, one of the one or more memories 820 may be a hard disk drive or another storage medium located in a housing different from the housing of each of the one or more computing devices (not shown) described above. Therefore, references to processors, computers, computing devices, or memories should be interpreted to include references to a set of processors, computers, computing devices, or memories which may or may not operate in parallel.

The expression “A or B” in the specification and claims includes the cases of “A and B” and “A or B”, and does not exclusively include only “A” or only “B” unless specifically stated otherwise.

In the disclosure, the reference to “an embodiment” or “some embodiments” means that the feature, structure, or characteristic described in combination with the embodiment is included in at least one embodiment or at least some embodiments of the disclosure. Therefore, the recitations of the expressions “in an embodiment” and “in some embodiments” in various paragraphs in this disclosure do not necessarily refer to the same one embodiment or the same several embodiments. In addition, in one or more embodiments, features, structures, or characteristics may be combined in any suitable combinations and/or sub-combinations.

As used herein, the term “exemplary” means “serving as an example, instance, or description” and does not mean serving as a “model” to be exactly copied. Any implementation exemplarily described herein is not necessarily interpreted as being preferred or advantageous over other implementations. Moreover, the disclosure is not limited by any expressed or implied theory in the sections of the technical field, related art, summary, or description of the embodiments described above.

In addition, some terminology may also be used in the following description for reference purposes only, and thus is not intended to be limiting. For example, unless clearly indicated in the context, the terms “first’, “second”, and other such numerical terms involving the structures or elements do not imply a sequence or order. It is also understood that, when the term “include/comprise” is used herein, it means that the indicated features, entireties, steps, operations, units, and/or components are present, but it does not exclude the presence or addition of one or more other features, entireties, steps, operations, units, and/or components, and/or combinations of the above.

In the disclosure, the terms “component” and “system” are intended to refer to a computer-related entity, hardware, a combination of hardware and software, software, or software which is being executed. For example, a component may be, but is not limited to, a process, an object, an executable state, an execution thread, and/or a program which operates on the processor. With descriptions based on examples, both an application program operating on a server and the server may be a component. One or more components may be present inside an executed process and/or thread, and a component may be located on one computer and/or distributed between two or more computers.

Those skilled in the art should be aware that the boundaries between the above operations are merely illustrative. Multiple operations may be combined into a single operation, a single operation may be distributed in subsidiary operations, and the operations may be executed in an at least partially temporally overlapping manner. Also, alternative embodiments may include multiple examples of specific operations, and the sequence of operations may be changed in other various embodiments. Nonetheless, other modifications, changes, and replacements are also possible. Therefore, the specification and drawings should be regarded as illustrative rather than limiting.

In addition, the embodiments of the disclosure may also include the following examples:

1 .A computer-executable method for assisting a user in plant care, including:

receiving a plant added by the user;

determining a care task of the plant at least according to a type of the plant, a planting location of the plant, and a current time; and

prompting the user of the care task of the plant.

2. The method according to 1, further including:

determining a climatic region of the plant according to the planting location of the plant;

determining a seasonal unit according to the climatic region of the plant and the current time; and

determining the care task of the plant according to the type of the plant and the seasonal unit.

3. The method according to 1, further including:

determining a geographic region of the plant according to the planting location of the plant;

determining a seasonal unit according to the geographic region of the plant and the current time; and

determining the care task of the plant according to the type of the plant and the seasonal unit.

4. The method according to 2 or 3, further including:

determining a growth stage of the plant; and

determining the care task of the plant according to the type of the plant, the seasonal unit, and the growth stage of the plant.

5. The method according to 4, where the growth stage of the plant is determined according to an input of the user.

6. The method according to 4, where the growth stage of the plant is determined according to a planting time of the plant and the current time.

7. The method according to 4, further including:

determining a planting environment of the plant according to an input of the user; and determining the care task of the plant according to the type of the plant, the seasonal unit, the growth stage of the plant, and the planting environment of the plant.

8. The method according to 1, where the step of determining the care task of the plant includes determining a frequency at which the care task should be executed, and the method further includes:

determining a date on which the care task should be executed according to the frequency at which the care task should be executed; and

prompting the user of the care task according to the date on which the care task should be executed.

9. The method according to 8, further including:

obtaining a weather corresponding to the date on which the care task should be executed; and

prompting the user of the care task according to the date on which the care task should be executed and the weather.

10. The method according to 8, where the care task includes at least one of watering, spraying, water changing, water adding, fertilizing, pruning, weeding, pot turning, repotting, sunshining, sunshading, temperature adjustment, humidity adjustment, winter protection, and pest protection.

11. The method according to 2, where the climatic region is a climatic region classified according to the Koppen climate classification.

12. The method according to 2 or 3, where the seasonal unit includes one of early spring, mid spring, late spring, early summer, mid summer, late summer, early autumn, mid autumn, late autumn, early winter, mid winter, and late winter.

13. The method according to 4, where the growth stage includes one of a seed/seedling period, a growth period, a flowering period, a fruiting period, a dormant period, and a wither period.

14. The method according to 5, where the input of the user includes a picture showing a form of the plant and/or a text indicating the growth stage of the plant.

15. The method according to 7, where the planting environment of the plant includes at least one of indoor, outdoor, potted, ground-grown, soil cultured, and hydroponic.

16. A computer-executable method for assisting a user in plant care, including:

receiving multiple plants added to a garden created by the user;

determining at least one care task of each of the plants at least according to a type of each of the plants, a location of the garden, and a current time; and

prompting the user of each of the care tasks of the multiple plants.

17. The method according to 16, further including:

determining an execution frequency of each of the care tasks of each of the plants at least according to the type of each of the plants, the location of the garden, and the current time;

determining a date on which each of the care tasks of each of the plants should be executed at least according to the execution frequency of each of the care tasks of each of the plants; and

prompting the user of each of the care tasks of each of the plants according to the date.

18. The method according to 17, further including:

determining whether days of interval between the determined date on which the care task should be executed and a nearest weekend satisfy an adjustment condition; and

adjusting the determined date on which the care task should be executed to the nearest weekend in response to satisfying the adjustment condition.

19. The method according to 18, where the adjustment condition is being less than 20% of days of a repetition interval of the care task.

20. The method according to 17, where the care tasks of the multiple plants include a first care task and a second care task, and the method further includes:

determining whether days of interval between determined dates on which the first care task and the second care task should be executed satisfy an adjustment condition; and

adjusting the determined date on which the first care task should be executed to the determined date on which the second care task should be executed in response to satisfying the adjustment condition.

21. The method according to 20, where days of a repetition interval of the first care task are not less than days of a repetition interval of the second care task.

22. The method according to 17, further including:

obtaining a schedule of the user;

determining whether the determined date on which the care task should be executed conflicts with the schedule of the user; and

adjusting the determined date on which the care task should be executed to a date which does not conflict with the schedule of the user in response to conflicting with the schedule of the user.

23. The method according to 17, further including:

determining each of the care tasks as a more frequently repeated task or a less frequently repeated task according to the execution frequency of each of the care tasks of each of the plants;

establishing a recent task set and a future task set according to determined dates on which each of the care tasks of each of the plants should be executed, where the recent task set includes the more frequently repeated tasks and the less frequently repeated tasks, and the future task set includes the less frequently repeated tasks and does not include the more frequently repeated tasks; and

prompting the user of the recent task set and the future task set.

24. The method according to 16, further including:

determining, in response to receiving a location inputted by the user, the location of the garden as the location inputted by the user; and

determining, in response to not receiving the location inputted by the user, the location of the garden according to positioning information of the electronic device.

25. The method according to 16, further including:

providing a user interface, and prompting the user of each of the care tasks of the multiple plants via the user interface.

26. The method according to 25, where the user interface includes a first page, and the method further includes:

displaying the first page to prompt the user of each of the care tasks of the multiple plants in response to receiving a first operation of the user on the user interface, where the first page includes a care task list of a current time period and a future time period displayed in a form of entries.

27. The method according to 26, where a care task entry in the care task list includes a name of the care task and a number of plants associated with the care task.

28. The method according to 26, where the first page further includes a first sub-page collapsed by default, and the method further includes:

displaying the first sub-page in the first page in response to receiving an operation of the user on an entry of a third care task in the care task list, where the first sub-page includes sub-entries of one or more plants associated with the third care task.

29. The method according to 28, where each of the sub-entries includes at least one of:

a name of the plant;

a picture of the plant;

notes on executing the care task; and

a frequency of executing the care task.

30. The method according to 29, where each of the sub-entries further includes a delay/ignore option, and the method further includes:

delaying/ignoring prompting the user of the third care task of the plant corresponding to the sub-entry in response to receiving an operation of the user on the delay/ignore option.

31. The method according to 29, where each of the sub-entries further includes a completion option, and the method further includes

ending prompting the user of the third care task of the plant corresponding to the sub-entry in response to receiving an operation of the user on the completion option.

32. The method according to 28, where the user interface further includes a second page, and the method further includes:

displaying the second page in response to receiving a second operation of the user on a first plant in the first sub-page, where the second page includes guidance for executing the third care task on the first plant.

33. The method according to 25, where the user interface further includes a third page, and the method further includes:

displaying the third page to prompt the user of each of the care tasks of the multiple plants in response to receiving a third operation of the user on the user interface, where the third page includes care tasks of a current time period and a future time period displayed in a form of a calendar, where a first dimension of the calendar is associated with the date and a second dimension is associated with the multiple plants.

34. The method according to 25, where the user interface further includes a fourth page, and the method further includes:

displaying the fourth page to prompt the user of each of the care tasks of the multiple plants in response to receiving a fourth operation of the user on the user interface, where the fourth page includes a list of the multiple plants displayed in a form of entries.

35. The method according to 34, where each plant entry in the list of the multiple plants includes a name of the plant and/or a picture of the plant.

36. The method according to 34, where the user interface further includes a fifth page, and the method further includes:

displaying the fifth page in response to receiving a fifth operation of the user on a second plant in the list of the multiple plants, where the fifth page includes information of the second plant and one or more care tasks of the second plant.

37. The method according to 36, where the user interface further includes a sixth page, and the method further includes:

displaying the sixth page in response to receiving a sixth operation of the user on a fourth care task among the one or more care tasks, where the sixth page includes information of the fourth care task.

38. The method according to 16, further including:

receiving at least one plant added to a wish list created by the user;

determining a suitable planting period of the at least one plant according to a type of the at least one plant and the location of the garden; and

prompting the user to plant the at least one plant according to the suitable planting period and the current time.

39. The method according to 38, where each of the plants in the wish list includes a planted option, and the method further includes:

removing a third plant from the wish list and adding the third plant to the garden in response to receiving an operation of the user on the planted option of the third plant among the at least one plant.

40. The method according to 16 or 39, further including:

displaying a seventh page to receive a planting environment of a fourth plant from the user in response to the fourth plant being added to the garden; and

further determining at least one care task of the fourth plant according to the planting environment of the fourth plant.

41. The method according to 40, further including:

providing an option of the planting environment and a default value of the option through the seventh page; and

determining the planting environment of the fourth plant as the default value in response to the user not operating on the option.

42. The method according to 40, further including:

receiving a picture associated with the planting environment of the fourth plant through the seventh page; and

determining the planting environment of the fourth plant according to an identification result of the picture.

43. The method according to 40, where the planting environment includes at least one of indoor, outdoor, potted, ground-grown, soil cultured, and hydroponic.

44. A computer-executable method for assisting a user in plant care, including: receive a plant added by the user;

determining a growth stage of the plant;

determining a care task of the plant at least according to a type of the plant and the growth stage of the plant; and

prompting the user of the care task of the plant.

45. The method according to 44, where the growth stage of the plant is determined according to an input of the user.

46. The method according to 45, where the input of the user includes a picture showing a form of the plant and/or a text indicating the growth stage of the plant.

47. The method according to 44, where the growth stage of the plant is determined according to a current time.

48. The method according to 44, where the growth stage includes one of a seed/seedling period, a growth period, a flowering period, a fruiting period, a dormant period, and a wither period.

49. The method according to 44, further including prompting the care task of the plant to a user associated with the user.

50. The method according to 44, where the care task includes at least one of watering, spraying, water changing, water adding, fertilizing, pruning, weeding, pot turning, repotting, sunshining, sunshading, temperature adjustment, humidity adjustment, winter protection, and pest protection.

51. A computer system for assisting a user in plant care, including:

one or more processors; and

one or more memories configured to store a series of computer-executable commands,

where when the series of computer-executable commands are executed by the one or more processors, the one or more processors are caused to perform the method according to any one of 1-50.

52. A non-transitory computer-readable storage medium, storing a series of computer-executable commands, where when the series of computer-executable commands are executed by one or more computing devices, the one or more computing devices are caused to perform the method according to any one of 1-50.

Although some specific embodiments of the disclosure have been described in detail through examples, those skilled in the art should understand that the above examples are only illustrative and are not intended to limit the scope of the disclosure. The various embodiments disclosed herein may be combined arbitrarily without departing from the spirit and scope of the disclosure. Those skilled in the art should also understand that various modifications may be made to the embodiments without departing from the scope and spirit of the disclosure. The scope of the disclosure is defined by the appended claims.

What is claimed is:

1. A computer-executable method for assisting a user in plant care, comprising:
receiving a plant added by the user;
determining a care task of the plant at least according to a type of the plant, a planting location of the plant, and a current time; and
prompting the user of the care task of the plant.

2. The method according to claim 1, further comprising:
determining a climatic region and/or a geographic region of the plant according to the planting location of the plant;
determining a seasonal unit according to the climatic region and/or the geographic region of the plant and the current time; and
determining the care task of the plant according to the type of the plant and the seasonal unit.

3. The method according to claim 2, further comprising:
determining a growth stage of the plant; and
determining the care task of the plant according to the type of the plant, the seasonal unit, and the growth stage of the plant,
wherein the growth stage of the plant is determined according to an input of the user or a planting time of the plant, and
the input of the user comprises a picture showing a form of the plant and/or a text indicating the growth stage of the plant.

4. The method according to claim 3, further comprising:
determining a planting environment of the plant according to an input of the user; and
determining the care task of the plant according to the type of the plant, the seasonal unit, the growth stage of the plant, and the planting environment of the plant.

5. The method according to claim 1, wherein the step of determining the care task of the plant comprises determining a frequency at which the care task should be executed, and the method further comprises:
determining a date on which the care task should be executed according to the frequency at which the care task should be executed; and
prompting the user of the care task according to the date on which the care task should be executed.

6. The method according to claim 3, wherein the growth stage comprises one of a seed/seedling period, a growth period, a flowering period, a fruiting period, a dormant period, and a wither period.

7. The method according to claim 4, wherein the planting environment of the plant comprises at least one of indoor, outdoor, potted, ground-grown, soil cultured, and hydroponic.

8. A computer-executable method for assisting a user in plant care, comprising:
receiving a plurality of plants added to a garden created by the user;
determining at least one care task of each of the plants at least according to a type of each of the plants, a location of the garden, and a current time; and
prompting the user of each of the care tasks of the plurality of plants.

9. The method according to claim 8, further comprising:
determining an execution frequency of each of the care tasks of each of the plants at least according to the type of each of the plants, the location of the garden, and the current time;
determining a date on which each of the care tasks of each of the plants should be executed at least according to the execution frequency of each of the care tasks of each of the plants; and
prompting the user of each of the care tasks of each of the plants according to the date.

10. The method according to claim 9, further comprising:
determining whether days of interval between the determined date on which the care task should be executed and a nearest weekend satisfy an adjustment condition; and
adjusting the determined date on which the care task should be executed to the nearest weekend in response to satisfying the adjustment condition,
wherein the adjustment condition is being less than 20% of days of a repetition interval of the care task.

11. The method according to claim 9, wherein the care tasks of the plurality of plants comprise a first care task and a second care task, and the method further comprises:
determining whether days of interval between determined dates on which the first care task and the second care task should be executed satisfy an adjustment condition; and
adjusting the determined date on which the first care task should be executed to the determined date on which the second care task should be executed in response to satisfying the adjustment condition,
wherein days of a repetition interval of the first care task are not less than days of a repetition interval of the second care task.

12. The method according to claim 9, further comprising:
obtaining a schedule of the user;
determining whether the determined date on which the care task should be executed conflicts with the schedule of the user; and
adjusting the determined date on which the care task should be executed to a date which does not conflict with the schedule of the user in response to conflicting with the schedule of the user.

13. The method according to claim 9, further comprising:
determining each of the care tasks as a more frequently repeated task or a less frequently repeated task according to the execution frequency of each of the care tasks of each of the plants;
establishing a recent task set and a future task set according to determined dates on which each of the care tasks of each of the plants should be executed, wherein the recent task set comprises the more frequently repeated tasks and the less frequently repeated tasks, and the future task set comprises the less frequently repeated tasks and does not comprise the more frequently repeated tasks; and
prompting the user of the recent task set and the future task set.

14. The method according to claim 8, further comprising:
providing a user interface, and prompting the user of each of the care tasks of the plurality of plants via the user interface,
wherein the user interface comprises a first page, and the method further comprises:
displaying the first page to prompt the user of each of the care tasks of the plurality of plants in response to receiving a first operation of the user on the user interface, wherein the first page comprises a care task list of a current time period and a future time period displayed in a form of entries,
wherein a care task entry in the care task list comprises a name of the care task and a number of plants associated with the care task.

15. The method according to claim 14, wherein the first page further comprises a first sub-page collapsed by default, and the method further comprises:
displaying the first sub-page in the first page in response to receiving an operation of the user on an entry of a third care task in the care task list, wherein the first sub-page comprises sub-entries of one or more plants associated with the third care task,
wherein each of the sub-entries comprises at least one of:
a name of the plant;
a picture of the plant;
notes on executing the care task; and
a frequency of executing the care task.

16. The method according to claim 15, wherein the user interface further comprises a second page, and the method further comprises:
displaying the second page in response to receiving a second operation of the user on a first plant in the first sub-page, wherein the second page comprises guidance for executing the third care task on the first plant.

17. The method according to claim 14, wherein the user interface further comprises a third page, and the method further comprises:
displaying the third page to prompt the user of each of the care tasks of the plurality of plants in response to receiving a third operation of the user on the user interface, wherein the third page comprises care tasks of a current time period and a future time period displayed in a form of a calendar, wherein a first dimension of the calendar is associated with the date and a second dimension is associated with the plurality of plants.

18. The method according to claim 14, wherein the user interface further comprises a fourth page, and the method further comprises:
displaying the fourth page to prompt the user of each of the care tasks of the plurality of plants in response to receiving a fourth operation of the user on the user interface, wherein the fourth page comprises a list of the plurality of plants displayed in a form of entries, wherein each plant entry in the list of the plurality of plants comprises a name of the plant and/or a picture of the plant.

19. The method according to claim 18, wherein the user interface further comprises a fifth page, and the method further comprises:
displaying the fifth page in response to receiving a fifth operation of the user on a second plant in the list of the plurality of plants, wherein the fifth page comprises information of the second plant and one or more care tasks of the second plant.

20. The method according to claim 19, wherein the user interface further comprises a sixth page, and the method further comprises:
displaying the sixth page in response to receiving a sixth operation of the user on a fourth care task among the one or more care tasks, wherein the sixth page comprises information of the fourth care task.

21. The method according to claim 8, further comprising:
receiving at least one plant added to a wish list created by the user;
determining a suitable planting period of the at least one plant according to a type of the at least one plant and the location of the garden; and
prompting the user to plant the at least one plant according to the suitable planting period and the current time,
wherein each of the plants in the wish list comprises a planted option, and the method further comprises:
removing a third plant from the wish list and adding the third plant to the garden in response to receiving an operation of the user on the planted option of the third plant among the at least one plant.

22. The method according to claim 8, further comprising:
displaying a seventh page to receive a planting environment of a fourth plant from the user in response to the fourth plant being added to the garden; and
further determining at least one care task of the fourth plant according to the planting environment of the fourth plant.

23. The method according to claim 22, further comprising:
providing an option of the planting environment and a default value of the option through the seventh page; and
determining the planting environment of the fourth plant as the default value in response to the user not operating on the option.

24. The method according to claim 22, further comprising:
receiving a picture associated with the planting environment of the fourth plant through the seventh page; and
determining the planting environment of the fourth plant according to an identification result of the picture.

25. A computer system for assisting a user in plant care, comprising:
one or more processors; and
one or more memories configured to store a series of computer-executable commands,
wherein when the series of computer-executable commands are executed by the one or more processors, the one or more processors are caused to perform the method according to claim 1.
